(19) United States
(12) Patent Application Publication
(10) Pub. No.: US 2016/0279773 A1
(43) Pub. Date: Sep. 29, 2016

(54) DEVICE AND METHOD FOR BROKEN EXTRACTOR REMOVAL

(71) Applicant: Ray Fitzgerald Woods, Salem, OH (US)

(72) Inventor: Ray Fitzgerald Woods, Salem, OH (US)

(21) Appl. No.: 15/088,763

(22) Filed: Apr. 1, 2016

Related U.S. Application Data
(63) Continuation-in-part of application No. 14/668,881, filed on Mar. 25, 2015.

(51) Int. Cl. B25B 27/18

(52) U.S. Cl. CPC B25B 27/18

(57) ABSTRACT

A device and method of extracting a broken extractor are provided. The fastener extractor includes a shaft with a pre-formed center hole situated longitudinally and interiorly in the fastener extractor. An extractor removal tool is provided that is pre-formed to engage the pre-formed center hole in the extractor for removing a broken extractor and debri.

### CLAIM FOR PRIORITY

The present application is a Continuation In Part of application Ser. No. 14/668,881 filed Mar. 25, 2015 with the United States Patent and Trademark Office. The subject matter of which is incorporated herein by reference.

### BACKGROUND

1. Field

The present invention relates to traditional extractors used for removing broken threaded fasteners and more specifically extracting a broken extractor from a broken fastener.

2. Description of Related Art

Conventional extractors are round or square, solid, formed to a point, and spiral fluted or straight fluted. The spiral fluted extractors are threaded in the opposite direction of the broken fastener that is to be removed and square extractors have straight flutes. The extractor is formed so that once the broken fastener is center drilled the extractor is then inserted and rotated to remove the broken fastener. These conventional extractors leave no room for error in the aspect that if the extractor breaks or snaps off while attempting to remove the damaged fastener, it leaves a broken extractor inside of the broken fastener, therefore creating a compounded problem.

Traditional extractors are comprised of very hard steel, usually case hardened or heat treated, causing the steel to become so hard that it is almost brittle. It is well known to those that have utilized the conventional extractor not to drop them on concrete or other equally hard surfaces as it can easily compromise the strength of the extractor and will likely fail when used. Extractors are not easily drilled into by the common drill bit therefore, ruining multiple drill bits to achieve a deep enough hole in the broken extractor for it's removal. In some cases, removal of the broken extractor from the broken fastener cannot be achieved. This can present a time consuming and labor intensive process that can result in further damage or destruction of the bored component.

Many different extractors have been invented solving various problems presented while attempting to remove a damaged fastener, see for example U.S. Pat. Nos. 1,458,076, 1,754,736, 1,798,944, 1,875,484, 5,466,100, 6,098,499 and 7,152,509.

In U.S. Pat. No. 1,458,076 an “Extracting Device” having a nut member and angular portion that is engagable by a turning tool.

U.S. Pat. No. 1,754,736 is a “Screw Extractor” providing a tapered end with spiraled tapering with a blank surface between threads.

U.S. Pat. No. 1,798,944 claims a self-centering extractor with an impact head for hammering and flat narrow surfaces to allow for better seating in the broken fastener.

U.S. Pat. No. 1,875,484 discloses an extractor having a square body used to transmit rotational forces on the wall of the screw without shearing the metal.

U.S. Pat. No. 5,466,100 is directed to an extractor having a multispeed power drill bit with handle chuck adapter. This extractor has a hexagonal shank and multiple cylindrical surfaces with a decreasing diameter and a groove extending down the shank.

U.S. Pat. No. 6,098,499 is yet another extracting tool that has a tap member and driving head end and broach end.

U.S. Pat. No. 7,152,509 titled “Fastener Extractor” comprises an extractor and hand tool used on the end of the extractor for removing the fastener.

Accordingly, it is evident these conventional extractors do not address the possibility of the extractor itself being compromised while attempting to remove a damaged fastener, thus further complicating the fastener removal process. Therefore, it would be desirable to have a fastener extractor that did not need to be drilled in the event it broke off in the fastener and overcomes one or more of the disadvantages of the conventional extractor.

### BRIEF SUMMARY OF THE INVENTION

To alleviate the disadvantages of prior art, a fastener extractor is provided herein. The present invention comprises the conventional extraction tool for broken fasteners. Conventional extractors are normally round or square, solid, and formed to a point or taper from the head to the tapered end having gripping teeth, edges, surfaces, flutes, etc. on the outside of the shaft of the extractor that grip the drilled out broken fastener when the extractor is inserted and turned in the opposite direction of the threaded bolt. The head is formed to have a surface for a wrench, or other hand tool to engage for removal of the broken fastener.

The present invention comprises the conventional extractor having a pre-formed hole longitudinally and interiorly located through the center of the extractor with the hole opening situated in the center of the tip or tapered end of the extractor. The pre-formed center hole can run through the entire extractor from an opening in the head to an opening in the distal end being the tip or tapered end, or the pre-formed center hole can begin in the tapered end, being a blind hole, curtailed interiorly within the body of the extractor to a depth above the starting point of the exterior flutes or gripping surfaces. The pre-formed center hole can be machined in the fastener extractor in various forms including but not limited to square, round, threaded, hexagon, octagon, cross, star, or ribbed.

The pre-formed center blind hole that is curtailed within the body of the extractor is a desirable design because it is more economical from the manufacturing standpoint. Testing has proven that a conventional extractor will break in the fluted or tapered portion during usage, thus revealing the blind pre-formed center hole in the present invention. If an extractor did uncommonly break in the body portion of the extractor, typically a portion of the body would be protruding out of the broken fastener, enabling the user to grasp the remaining portion with a hand tool for removal. The extractor's hardened steel provides strength and rigidity even with a center hole machined and pre-formed longitudinally.

The pre-formed center hole that runs through the entire extractor also serves as a storage compartment for the extractor removal tool that when in its stored position fills the void in the pre-formed center hole. In the event the extractor fractures and breaks off, the pre-formed center hole allows for ease of removal of the broken extractor with the extractor removal tool. Thus eliminating the step of trying to drill out the conventional extractor, which is tedious, time consuming and sometimes impossible due to the nature of the heat-treated steel from which the extractor is composed.

The extractor removal tool is pre-formed to fit inside the current invention so that when rotated will remove the compromised extractor for ease of removal from the broken fastener. Variations of an extractor removal tool can be comprised by having a shaft defining a longitudinal axis. Also having a head that is affixed to one end of the said shaft, a head that is slidable along the said shaft, or a head that is threaded and rotates along the said shaft. The extractor removal tools that comprise a slidable head that is able to slide along said shaft have an affixed head attached to one end of the shaft utilized to retain said slidable head on said shaft while in use. The affixed head can be shaped as a thin piece of round steel or have a plurality of surfaces and ridges adapted to be engaged with a wrench or hand tool of the like. Yet another variation of an extractor removal tool is provided preinstalled within the current invention comprising a flexible cable freestanding within the pre-formed center hole of the extractor.

There are three methods provided for removing a broken fastener extractor, each executed with similar but having diverse removal tools for each method of removal. The aforementioned methods being a rotate-out method, a pullout method, and a jackscrew method, with diverse methods and various removal tools further described in detail under the detailed description portion hereafter. The extractor removal tool can be comprised of hard steel (ex. 4140 steel or the like thereof because there are various metal compositions with lower carbon that provide both qualities) that allows the steel of the removal tool to grip and bite the interior of the broken extractor all while the steel will flex enough that the extractor removal tool won't compromise.

Once choosing and executing one of the aforementioned removal methods, an uncompromised extractor with pre-formed center hole can be reinserted in the broken fastener and the process starts again. The current invention alleviates the possibility of permanently damaging the bored component and the necessity of drilling into the heat-treated steel of the fastener extractor, which is consequently a long involved process and many times unachievable.

### BRIEF DESCRIPTION OF THE DRAWINGS

FIG. 1 is a perspective view of the current invention showing the extractor with a pre-formed square center through hole and spiral flutes.

FIG. 2 is a perspective view example of an extractor removal tool with a sliding head and thin, flat, round, steel affixed head.

FIG. 3 is a perspective view of the current invention as a spiral fluted extractor showing the extractor removal tool with sliding head, stored in the extractor with pre-formed center through hole.

FIG. 4 is a perspective view of the current invention in square form with straight flutes and a blind pre-formed center hole.

FIG. 5 is a sectional view of the current invention showing a blind pre-formed center hole in the extractor of FIG. 4.

FIG. 6 illustrates the current invention demonstrating a broken straight fluted extractor and a variation option being a threaded removal tool and other required components for utilizing the pullout method for removal of said damaged fastener extractor.

FIG. 7 illustrates the current invention demonstrating a broken straight fluted extractor and a variation option of a threaded removal tool used for the jackscrew method of removing a damaged fastener extractor.

FIG. 8 is a perspective view example of another variation of an extractor removal tool, being a flexible cable, preinstalled in an extractor with a through pre-formed center hole.

FIG. 9 is a sectional view of FIG. 8 illustrating the extractor removal tool, being a flexible cable, preinstalled in the extractor with a through pre-formed center hole.

FIG. 10 is an illustration of the preinstalled extractor removal tool and components and demonstrating the pullout method of removing a broken extractor.

### DETAILED DESCRIPTION OF THE INVENTION

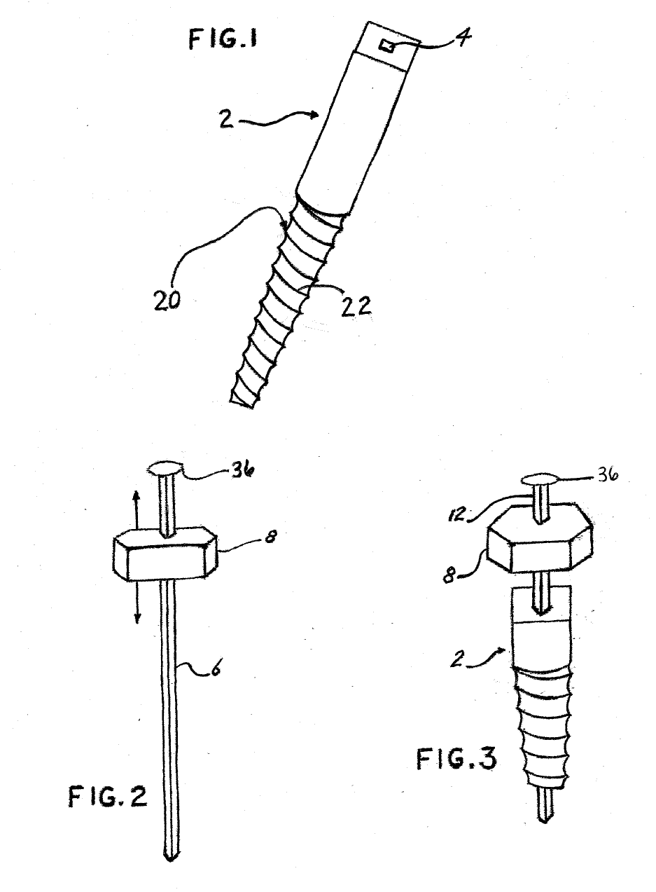

Referring now to FIGS. 1-7, in FIG. 1 is a perspective view of the current invention, an extractor with a through pre-formed center hole 2 comprised of case hardened or heat treated steel having a pre-formed center hole 4 longitudinally located through the center of the extractor with an opening in the center of the head and the distal end. The fastener extractor with a through pre-formed center hole 2 having a head with a plurality of surfaces and ridges adapted to be engaged with a wrench or other hand tool of the like. The distal end being the tapered end 20 is comprised of various gripping teeth, edges, flutes 22, and surfaces on the exterior of the extractor. FIG. 2 is a perspective view of a square extractor removal tool 6 and components. The square extractor removal tool 6 having a longitudinal axis is further defined by having a sliding head 8, an affixed head 36, and a distal end shaft. The sliding head 8 of the square extractor removal tool 6 is formed with a through center hole engagable on the shaft of the square extractor removal tool 6 and is able to slide freely on the shaft allowing the sliding head 8 to move closer to a bored component containing a broken fastener and broken extractor for ease in removing the broken extractor. Above the sliding head 8 attached to the shaft of the square extractor removal tool 6 is the affixed head 36 that is pictured as a thin round piece of steel permanently attached to the removal tool shaft in FIGS. 2 and 3, and utilized to stop the extractor removal tool shaft from sliding through the bottom of the sliding head 8. The square extractor removal tool 6 seats and engages in the pre-formed center hole 4 of the extractor with through pre-formed center hole 2. FIG. 3 is a perspective view showing an extractor removal tool in its stored position 12 within the extractor with through pre-formed center hole 2. The various shaped extractor removal tools can be comprised of hard steel with lower carbon composition and is pre-formed in a manner so that when inserted into an extractor with a pre-formed center hole, it fills the void of the pre-formed center hole 4, being a through pre-formed center hole or a blind pre-formed center hole 16, as seen in FIG. 5. The hard steel (ex. 4140 steel, alloys or the like there of) comprising the extractor removal tool's shaft, sliding head 8, threaded rotating head 30, or affixed head 36 as shown in FIGS. 2, 3, 6, 7, and 10 allows for the removal tool to flex rather than break but is rigid enough to grip or bite the interior walls of the extractor while being rotated to remove a broken extractor 32. The various extractor removal tools can also be magnetized to aide in the extractor and debri removal. The through pre-formed center hole 4 or blind pre-formed center hole 16 of the extractor, the extractor removal tool's shaft, and through hole of the sliding head 8 or threaded rotating head 30 can be machined or formed in a plurality of shapes including but not limited to: circle, square, cross, hexagon, octagon, ribbed, threaded, star, etc.

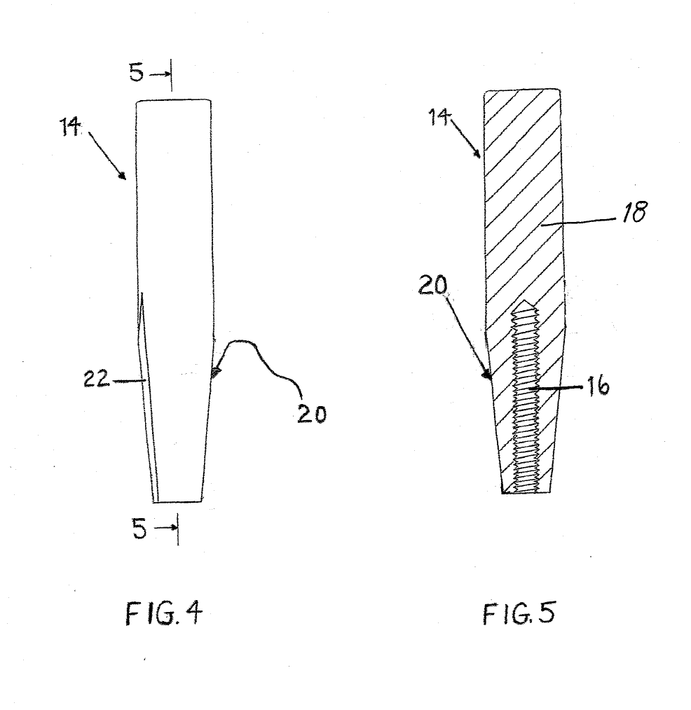

FIG. 4 is a perspective view of the current invention showing a square straight fluted extractor with blind pre-formed center hole 14. FIG. 5 features a sectional view of FIG. 4 with the blind pre-formed center hole 16 beginning in the tapered end of the extractor 20 and extends interiorly and is curtailed in the body of the extractor 18. The blind pre-formed center hole 16 that begins in the tapered end of the extractor 20 and runs interiorly and longitudinally to a point above where the exterior flutes 22 end being above the exterior working area of the extractor and in the body of the fastener extractor 18.

Testing has proven that when an extractor breaks, it is in the fluted 22 portion when being utilized to remove a broken fastener. Because the extractor breaks in the aforementioned portion, it is evident that as long as the blind pre-formed center hole 16 extends above the exterior flutes 22, the blind pre-formed center hole 16 will become accessible to insert an extractor removal tool if the extractor breaks while in use. The option of using a blind pre-formed center hole 16 in the current invention provides for a more economical manufacturing option and provides the same advantages as the aforementioned through pre-formed center hole 4 shown in FIG. 1. Due to the case hardening or heat treating process of the steel used to construct extractors, machining of the through pre-formed center hole 4 and blind pre-formed center hole 16 should occur before the hardening process takes place in order to allow for easy and economical machining. If the process of electrical discharge machining (EDM) becomes more cost efficient in the future, it may become cost effective to EDM the hole after heat treating or case hardening the fastener extractor. It is assumed that one skilled in the art has knowledge of the aforementioned hardening process and electrical discharge machining process.

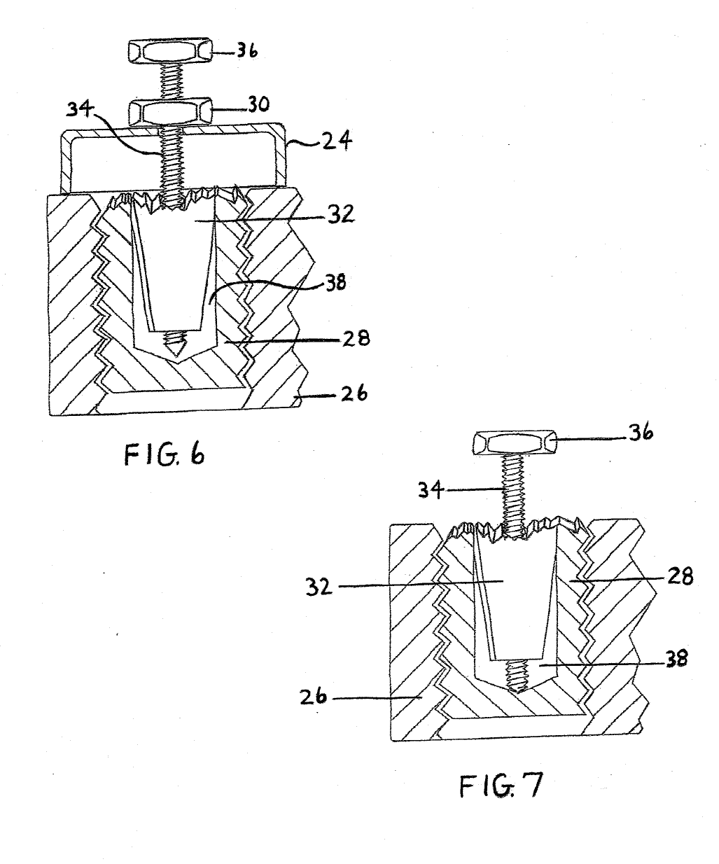

There are three basic methods for removing a broken extractor 32, two of which are shown in FIGS. 6, 7, and 10. The first method being the rotate-out method, which is not pictured because of it's simplicity, entails using a spiral fluted extractor and extractor removal tool having a longitudinal defining axis shaft with affixed head 36 and/or threaded rotating head 30, pictured in FIGS. 6, 7, and 10 or sliding head 8. If the removal tool shaft comprises utilizing a threaded rotating head 30 or slidable head 8, an affixed head 36, pictured in FIGS. 2 and 3. as a thin round piece of steel, will be attached to the top of the removal tool shaft to retain said head from sliding or rotating off the top of said removal tool shaft while in use. Once the current invention, being of the spiral fluted type extractor, having a through pre-formed center hole 4, as seen in FIG. 1, or having a blind pre-formed center hole 16, pictured in FIG. 5 (with the variation of being straight fluted which does not apply in this method of removal), becomes compromised and breaks off in the drilled hole 38 of the broken fastener 28, one of the aforementioned extractor removal tools is inserted into the broken extractor 32. If using the extractor removal tool with an affixed head 36, adapted to be engaged with a wrench or hand tool of the like, once inserted into the broken extractor 32, simply use a wrench or other hand tool of the like to rotate the affixed head 36 of the removal tool in the opposite direction the spiral fluted fastener extractor was rotated into the broken fastener 28, thus causing the broken extractor 32 to rotate-out of the broken fastener 28. If using the aforementioned slidable head 8, allow the head to slide down the removal tool shaft, that is inserted in the broken extractor 32, until it comes into contact with the broken extractor 32, broken fastener 28, or bored component 26, whichever it comes into contact with first. Again utilizing a wrench or hand tool of the like, rotate the slidable head 8 in the opposite direction the broken extractor 32 was rotated into the broken fastener 28 until the broken extractor 32 is rotated-out of the broken fastener 28. If utilizing an extractor removal tool with a threaded rotating head 30, rotate the threaded rotating head 30 up until it contacts the affixed head 36 and insert the removal tool shaft into the pre-formed center hole of the broken extractor 32 and rotate the removal tool shaft into the broken extractor 32 until the threaded rotating head 30 contacts the broken extractor 32. If the removal tool shaft is too long and bottoms out, back-out the removal tool shaft a ¼″ and rotate the threaded rotating head 30 down the removal tool shaft until it contacts the broken extractor 32. Utilizing a wrench or hand tool of the like rotate the threaded rotating head 30 in the opposite direction the extractor was rotated into the broken fastener 28 until the broken extractor 32 is rotated-out of the broken fastener 28.

Now referring to FIG. 6, this figure depicts the pullout method for removal of a broken fastener extractor 32. Providing an extractor being either spiral or straight fluted type, with a through pre-formed center hole 4 or a blind pre-formed center hole 16 with either type having the preferred embodiment of a threaded hole. Either of the aforementioned fastener extractors is then inserted into the drilled hole 38 of the broken fastener 28, rotated for removal of the broken fastener 28, with the said fastener extractor being compromised during use while attempting to remove the broken fastener 28. A threaded removal tool 34 having an affixed head 36 and threaded rotating head 30 on said threaded removal tool's 34 shaft is rotated up the said shaft until the threaded rotating head 30 contacts the bottom of the affixed head 36. Also provided is a spacer 24 being round or square and having a solid flat top surface, formed as a bridge having two support members with flat edges on which the spacer 24 rests. The spacer 24 has a round center through hole large enough said shaft can pass through without resistance. The threaded removal tool's 34 shaft is then inserted into the center hole of said spacer 24. The remaining threaded removal tool's 34 shaft is then inserted into the broken extractor 32 and using a wrench or hand tool of the like to rotate the affixed head 36 of the threaded removal tool 34 down into the threaded center hole of the broken extractor 32 until the threaded rotating head 30 is in contact with the spacer 24 that is resting on the bored component 26 or the broken fastener 28. If the threaded removal tool 34 bottoms out within the broken extractor 32 or broken fastener 28 back-out the threaded removal tool 34 a ¼″ and rotate the threaded rotating head 30 down until it contacts the spacer 24. Then the affixed head 36 is held with a wrench or similar tool, while utilizing another wrench or hand tool to rotate the threaded rotating head 30 down toward the spacer 24 forcing the threaded removal tool 34 that is threaded into the broken extractor 32 to pullout the broken extractor 32 out of the broken fastener 28.

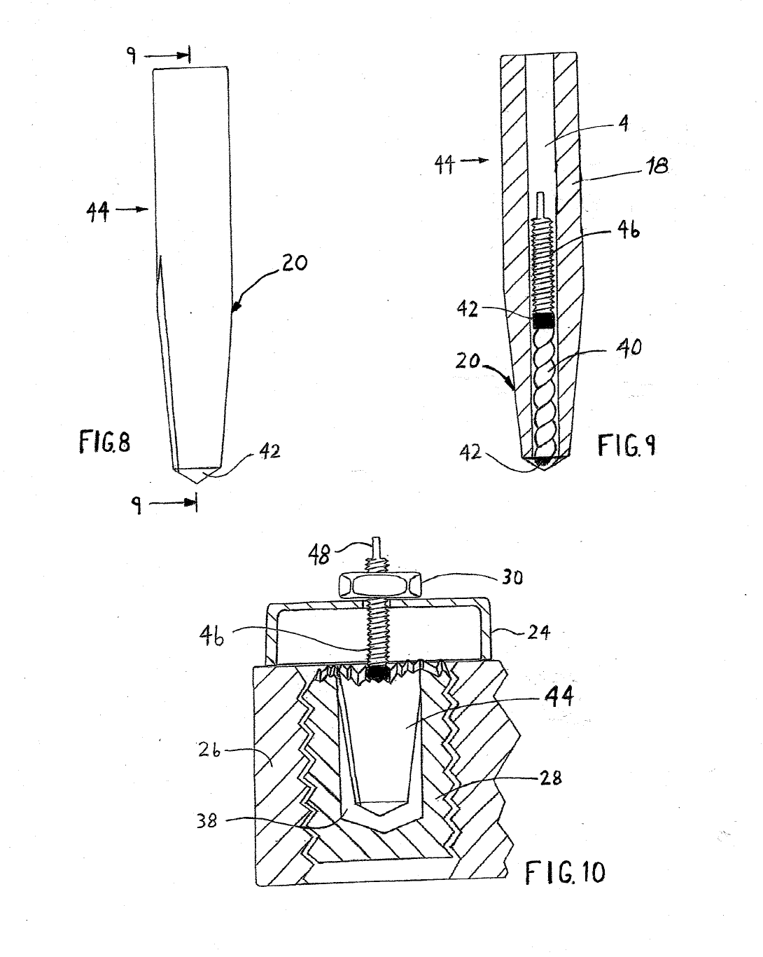

Illustrated in FIG. 8, is an extractor with a preinstalled removal tool 44. The fastener extractor with a preinstalled removal tool 44 can be a spiral fluted or straight fluted type extractor with a through pre-formed center hole 4 as seen in FIG. 9 or a with a blind pre-formed center hole 16 as seen in FIG. 5. FIG. 9 is a sectional view of the extractor with a preinstalled removal tool 44 which depicts a through pre-formed center hole 4 with a flexible cable 40 preinstalled. The flexible cable 40 is permanently affixed by a weld 42 at the tip of the tapered end of the extractor 20 with the end of the flexible cable 40 and the tip of the fastener extractor being as one at the point of attachment. The flexible cable 40 is permanently affixed by a weld 42 to the threaded rod 46 on the opposite end of the flexible cable 40 which is welded to the tip of the extractor; both the flexible cable 40 and threaded rod 46 are preinstalled interiorly within the extractor and freestanding of the interior walls therein the extractor's through pre-formed center hole 4. This variation of the current invention also utilizes the pullout method of removal and is illustrated in FIG. 10. Now referring to FIGS. 9 and 10, after the extractor with preinstalled removal tool 44 is inserted into the drilled hole 38 of the broken fastener 28, rotated to remove the broken fastener 28, and is compromised, the flexible cable 40, pictured in FIG. 9 is able to bend and flex inside of the compromised extractor. The flexible cable 40 and affixed threaded rod 46 have a diameter smaller than the through pre-formed center hole 4 as seen in FIG. 9 and the upper portion of the broken extractor with a preinstalled removal tool 44 can slide off the flexible cable 40 and affixed threaded rod 46, leaving the tapered end of the extractor 20 lodged in the broken fastener 28 and exposing the flexible cable 40 and affixed threaded rod 46. The aforementioned spacer 24 is positioned over the broken extractor with preinstalled removal tool 44 with the affixed threaded rod 46 extending through the center hole of the spacer 24. A threaded rotating head 30 is rotated onto the affixed threaded rod 46 above the spacer 24 until it contacts the top surface of the spacer 24. The affixed threaded rod 46 is then held at the tip 48, formed to be engaged with a wrench or hand tool of the like, while the threaded rotating head 30 is rotated, utilizing a separate wrench or hand tool of the like, down on the spacer 24. The flexible cable 40 that is affixed by a weld 42 to the tip of the extractor and attached at the opposite end to the affixed threaded rod 46, will begin to pullout the broken extractor with preinstalled removal tool 44 from the broken fastener 28 as the threaded rotating head 30 is rotated down on the affixed threaded rod 46 and spacer 24.

The third method, depicted in FIG. 7 is the jackscrew method for removing a broken extractor 32, which requires an extractor with spiral flutes or straight flutes having a through pre-formed center hole 4 as seen in FIGS. 1 and 9 or a blind pre-formed center hole 16 as seen in FIG. 5, with either type having the preferred embodiment of a threaded hole and a threaded removal tool 34 having an affixed head 36 that is engagable with a wrench or hand tool of the like. The broken fastener 28 must be drilled providing a hole for the aforementioned extractor, with the drilled hole 38 being a blind hole and just deeper than the length of the fluted portion of the aforementioned extractor, and with the broken fastener 28 having sufficient body left in the bottom to be used as a contact surface for the threaded removal tool 34. After one of the aforementioned extractors is inserted into the drilled hole 38 of the broken fastener 28 and rotated in the opposite direction the fastener was applied into the bored component 26 in attempt to remove the broken fastener 28 and the aforementioned extractor fails and is compromised, the threaded removal tool 34 with affixed head 36 is rotated into the threaded pre-formed center hole of the broken extractor 32 utilizing a wrench or hand tool of the like to engage the affixed head 36 of the threaded removal tool 34. As the threaded removal tool 34 is rotated down into the broken extractor 32 it will protrude out of the bottom of the broken extractor 32 and contact the bottom of the drilled hole 38 in the broken fastener 28. As the threaded removal tool 34 is continually rotated and in contact with the bottom of the drilled hole 38 of the broken fastener 28 it will begin to rotate and jackscrew out the broken extractor 32.

Once a broken extractor 32 is removed from the broken fastener 28 an uncompromised extractor with a pre-formed center hole can be inserted into the drilled hole 38 of the broken fastener 28 and the fastener removal process can promptly start again.

While the present invention has been described in both summarized and detailed form, it is understood that the through pre-formed center hole 4, blind pre-formed center hole 16, extractor removal tool's 6 shaft, and center hole in the sliding head 8 as seen in FIGS. 1, 2, and 5, can be machined in various shapes (ex. hexagon, octagon, circle, cross, square and able to be ribbed or threaded etc.) and can be integrated into various types and brands of extractors without departing from the spirit of the invention. Therefore I claim:

1. A fastener extractor comprising:
a shaft defining a longitudinal axis:
a shaft member comprised of heat treated or case hardened steel having a head and distal tapered end; and
said shaft member having a machined and pre-formed center hole positioned interiorly and longitudinally through a center of the extractor shaft; and
the pre-formed center hole having a plurality of surfaces further comprised of a shape formed as a circle, square, octagon, hexagon, or cross with an option of being threaded or ribbed; and
said shaft member being conical or square with a plurality of biting surfaces, flutes, and edges disposed about the exterior longitudinal axis being the distal tapered end; and
the head having a plurality of exterior surfaces and ridges adapted to be engaged with a wrench or other hand tool of the like; and
said fastener extractor flutes having a rotational direction opposite of a fastener.

2. The fastener extractor of claim 1 wherein said head having an engagement opening; and
said engagement opening being the pre-formed center hole; and
said pre-formed center hole being a through hole positioned interiorly and longitudinally through said center of said fastener extractor; and
said through hole extends through the distal tapered end of said extractor.

3. The fastener extractor of claim 2 wherein said through pre-formed center hole is machined in said fastener extractor prior to the hardening or heat treating process.

4. The fastener extractor of claim 2 wherein said through pre-formed center hole is machined in said fastener extractor subsequently to the hardening or heat treating process.

5. The fastener extractor of claim 1 wherein the machined and pre-formed center hole beginning in said tapered end thereof; and
said machined and pre-formed center hole being a blind hole; and
said blind hole extends interiorly having a predetermined length being above the exterior tapered fluted portion of said fastener extractor and being curtailed within a body thereof.

6. The fastener extractor of claim 5 wherein said blind pre-formed center hole is machined in said fastener extractor prior to said hardening or heat treating process.

7. The fastener extractor of claim 5 wherein said blind pre-formed center hole is machined in said fastener extractor subsequently to said hardening or heat treating process.

8. An extractor removal tool comprising:
a shaft defining a longitudinal axis:
a shaft member comprised of low carbon steel or alloy steel having an ability to be magnetized; and
the shaft exterior having a machined and pre-formed shape conformed to a fastener extractor pre-formed center hole; and
the shaft member having a length greater than a fluted tapered portion of a fastener extractor; and
said shaft member having an affixed head permanently attached to a first end thereof; and
said shaft member having a rotational direction opposite of a fastener extractor.

9. The extractor removal tool of claim 8 wherein said affixed head having a plurality of surfaces and ridges adapted to be engaged with a wrench or hand tool of the like.

10. The extractor removal tool of claim 9 wherein said shaft member having a second head disposed thereof beneath said affixed head; and
said second head having a center hole pre-formed to engage on said shaft wherein the second head having the ability to slide or rotate freely on the shaft; and
the second head having a plurality of surfaces and ridges adapted to be engaged with a wrench or other hand tool of the like.

11. The extractor removal tool of claim 10 wherein a spacer is disposed on said shaft beneath said second head; and
said spacer being round or square having an overall diameter or width about one and half times larger than a fastener to be removed with a fastener extractor; and
said spacer having a solid flat upper surface and having a center round hole thereof; and
said center hole being a diameter larger than said shaft member: and
said spacer being affixed and elevated on dual support members; and
the affixed dual support members are permanently attached on a bottom side of said solid flat surface and distal from one another; and
said dual support members having bottom edges thereof being flat.

12. The extractor removal tool of claim 8 wherein said affixed head being a thin round flat steel member.

13. The extractor removal tool of claim 12 wherein said shaft member having a second head disposed thereof beneath said affixed head; and
said second head having a center hole pre-formed to engage on said shaft; and
where said second head having the ability to slide or rotate freely on said shaft; and
said second head having a plurality of surfaces and ridges adapted to be engaged with a wrench or hand tool of the like

14. The fastener extractor of claim 2:
wherein the through pre-formed center hole contains an extractor removal tool; and
said removal tool is comprised of a flexible cable with a threaded rod permanently affixed to a first end of said flexible cable; and
said threaded rod having a head distal from where said flexible cable is affixed thereof; and
said head having a plurality of surfaces and ridges adapted to be engaged with a wrench or hand tool of the like; and
where said flexible cable having a second distal end permanently affixed to the fastener extractor at the tip of the tapered portion thereof; and
where said flexible cable and attached threaded rod being retained within said fastener extractor pre-formed center hole and being freestanding thereof; and
said flexible cable and affixed threaded rod having a diameter smaller than said fastener extractor through and pre-formed center hole.

15. The fastener extractor of claim 5:
wherein the blind pre-formed center hole contains an extractor removal tool; and
said removal tool is comprised of a flexible cable with a threaded rod permanently affixed to a first end thereof; and
said threaded rod having a head distal from where said flexible cable is affixed thereto; and
said head having a plurality of surfaces and ridges adapted to be engaged with a wrench or hand tool of the like; and
where said flexible cable having a second distal end permanently affixed to the fastener extractor at a tip of the tapered portion thereof; and
said flexible cable and attached threaded rod being retained within said fastener extractor pre-formed center hole and being freestanding thereof; and
said flexible cable and affixed threaded rod having a diameter smaller than said fastener extractor blind and pre-formed center hole.

16. A method of extracting a damaged fastener extractor comprising:
the absence of drilling an opening in the hardened steel of a broken extractor;
providing a fastener extractor having a shaft defining a longitudinal axis where the shaft member being heat treated or case hardened steel having a head and distal tapered end, with said head having a machined and pre-formed center hole positioned interiorly and longitudinally through a center of the extractor, and having a through hole that begins in the head and extends through the distal tapered end of the extractor, or a fastener extractor having a blind pre-formed center hole, where said blind pre-formed center hole begins in the tapered end and being curtailed within a body of the fastener extractor, or a fastener extractor with a preinstalled removal tool, with said pre-formed center hole being a through hole or blind hole, and the preinstalled removal tool being a flexible cable with a first end permanently attached to a threaded rod, and said threaded rod having a head adapted to be engaged with a wrench or hand tool of the like distal to said flexible cable attachment, and where said flexible cable having a second end, and said second end being permanently attached to said fastener extractor with preinstalled removal tool at a tip of the tapered end, and said flexible cable and attached threaded rod being retained within said pre-formed center hole and being freestanding thereof, and where said shaft of aforementioned fastener extractors being conical or square with a plurality of biting surfaces, flutes, and edges disposed along the longitudinal axis being the tapered distal end, where the pre-formed center hole has a plurality of surfaces comprised of a shape formed as a circle, square, octagon, hexagon, or cross, with an option of being threaded or ribbed, and with said head exterior having a plurality of surfaces and ridges adapted to be engaged with a wrench or other hand tool of the like; and
providing an extractor removal tool comprising a shaft defining a longitudinal axis, where the shaft member is comprised of low carbon steel or alloy steel with an ability to be magnetized, and having an affixed head with a plurality of surfaces and ridges adapted to be engaged with a wrench, and where said shaft exterior having a machined and pre-formed shape conformed to said fastener extractor pre-formed center hole, and where the shaft member having a length greater than the tapered end of said fastener extractor and where a second head having a center hole conformed to said shaft member is provided, and the second head having an ability to slide or rotate freely on said shaft exterior, and said second head having a plurality of surfaces and ridges adapted to be engaged with a wrench or hand tool of the like, and where a spacer is provided and said spacer being round or square with a diameter or width being about one a half times greater than a fastener to be removed, and said spacer having a solid flat upper surface and having a center round hole thereof, and said center hole having a diameter greater than said shaft member, and the spacer being affixed and elevated on dual support members, and said dual support members being permanently attached to a bottom of said upper solid flat surface, and the dual support members being distal from one another and having a flat bottom edge, and where the extractor removal tool having a rotational direction opposite of said fastener extractor.

17. The method of claim 16 requires rotating a conical spiral fluted fastener extractor into a drilled hole of a broken fastener to remove said broken fastener, where the fastener extractor is compromised and broken while attempting to remove said broken fastener and where removing a broken fastener extractor from said broken fastener requires inserting the extractor removal tool shaft into the broken fastener extractor with a pre-formed center hole and requires rotating the extractor removal tool affixed head utilizing a wrench or hand tool of the like in the opposite direction said fastener extractor was rotated into said broken fastener urging said broken fastener extractor to rotate-out of the broken fastener.

18. The method of claim 16 requires rotating a square or conical fastener extractor, wherein the pre-formed center hole having the preferred embodiment of a round threaded hole, into a drilled hole of a broken fastener, and where the fastener extractor is compromised and broken while attempting to remove said broken fastener, and where removing a broken fastener extractor from said broken fastener requires utilizing a removal tool with the preferred embodiment of a threaded shaft and a threaded second head and requires rotating said second head up said removal tool shaft until the second head is contiguous with said first affixed head and the spacer is disposed on the threaded shaft beneath the second head and said spacer dual support members are resting on a bored component or said broken fastener and where the remaining threaded shaft member requires being inserted into the pre-formed center hole of the broken fastener extractor, and where utilizing a wrench or hand tool of the like to rotate said affixed head urging the threaded shaft into the threaded pre-formed center hole of the broken fastener extractor until said second head is contiguous with said spacer upper solid flat surface, and where holding said affixed head with said wrench while rotating a second wrench urging the second head down the shaft toward said spacer, and where rotating the second head urges the threaded removal tool to pullout said broken fastener extractor from the broken fastener.

19. The method of claim 16 requires rotating a square or conical fastener extractor into a drilled hole of a broken fastener, where said drilled hole being a blind hole curtailed by the remaining body of said broken fastener, wherein said drilled hole having a length greater than the fluted tapered portion of the fastener extractor, and where said fastener extractor is broken while attempting to remove the broken fastener, and where said fastener extractor with pre-formed center hole having the preferred embodiment of a round threaded hole thereof, and removal of said broken fastener extractor requires inserting and rotating said removal tool shaft into said pre-formed center hole of the broken fastener extractor and utilizing a wrench or hand tool of the like to rotate said affixed head, and where said extractor removal tool threaded shaft is rotated through the tapered end of said broken fastener extractor and contacts the bottom of said blind drilled hole in the broken fastener, and where continuing to rotate the threaded removal tool being bottomed out in the drilled hole of the broken fastener begins urging the broken fastener extractor to jackscrew out of said broken fastener.

20. The method of claim 16 requires rotating the fastener extractor with preinstalled removal tool being conical or square into a drilled hole of a broken fastener and where the fastener extractor is compromised and broken while attempting to remove said broken fastener, and where removing a broken fastener extractor from said broken fastener requires sliding an upper portion of the broken fastener extractor off said flexible cable and threaded rod, where the tapered portion of the broken fastener extractor being lodged within the broken fastener, and where inserting said threaded rod through the center hole of the provided spacer and rotating said threaded head on the threaded rod until said head is contiguous with said spacer, and utilizing a first wrench or hand tool of the like to hold said threaded rod head while utilizing a second wrench or hand tool of the like to rotate said threaded head urging thereof down on the threaded rod and said spacer upper surface and where said flexible cable first end being permanently affixed to the threaded rod and said flexible cable second end being permanently affixed to the tip of the tapered end of said broken fastener extractor and with said rotating of the threaded head urging said broken fastener extractor to pullout of said broken fastener.
